(19) United States
(12) Patent Application Publication
(10) Pub. No.: US 2006/0272209 A1
(43) Pub. Date: Dec. 7, 2006

(54) Multi-purpose decorative assembly

(76) Inventor: Thomas G. Hart, Lake Worth, FL (US)

Correspondence Address: MCHALE & SLAVIN, P.A., 2855 PGA BLVD, PALM BEACH GARDENS, FL, 33410, US

(21) Appl. No.: 11/146,559

(22) Filed: Jun. 7, 2005

(51) Int. Cl. A01G 9/02

(52) U.S. Cl. 47/66.6

(57) ABSTRACT

A table for use in combination with a container such as a flower pot or vase. The decorative table is formed from a frame that couples to the open end of the container wherein the container operates as a support base. A decorative item, such as a plant, is placed in therein and operates as a weighted base. A frame is secured to the container having a spaced upper end forming an upper support member. A planar tabletop is then secured to the upper support member providing a tabletop that can be used in a conventional manner.

### FIELD OF THE INVENTION

The present invention is directed towards a multi-purpose piece of furniture; particularly towards a decorative, multi-purpose furniture; most particularly toward an assembly that includes a frame support constructed and arranged to convert a container into a table and vice versa.

### BACKGROUND OF THE INVENTION

There is often a desire to provide furniture that acts to conserve valuable living space. For many individuals to whom indoor and/or outdoor living space is limited, modular furniture is the solution, in that it performs multiple functions while still remaining aesthetically pleasing.

For example, decorative containers, which house artificial or real plants, colorful bulbs, sand, rock, candles and the like, are commonly used to decorate indoor and outdoor areas. In addition, multi-tiered stands are a common means to display various decorations. However, most of these containers and stands reduce living space or difficult to transport, while providing no additional functionality.

While there are numerous commercially available stands, or tables, designed for displaying decorative items, many of these designs found in the prior art make no attempt to provide an assembly able to convert a container, such as decorative plant pot, into an attractive table when desired and vice versa, while still providing ready access to the decorative item(s) housed within the container.

For example U.S. Pat. No. 6,622,638 and U.S. Pat. No. 6,237,508 both to Weiss discloses a stand with a planar tabletop with an opening provided therethough. The stand also includes a removable tabletop disposed within the opening such that the upper surface of the tabletop insert is generally planar with the upper surface of the tabletop. To convert the stand to a decorative container, the tabletop insert is removed and a container is lowered through the opening until it is positioned where the tabletop insert was located. The alternate embodiment features an urn supported upright by a pedestal. In this embodiment, narrow interstices are provided which allow isual access into the interior portion of the urn where a container housing the decorative items may be housed. However, unlike the instant assembly, when the tabletop is in place over the container it must be entirely, or at least partially, removed from atop the container to provide access into the interior cavity of the container. This can be particularly onerous should the table/container assembly be used to house a living thing (e.g. plants, fish, etc), therein, as these need tending and in some instances require a significant amount of exposure to the surrounding environment.

U.S. Pat. No. 4,631,861 to Wuthrich describes a combination portable plant port and trellis for growing plants, flowers, vines and the like with a circumferential trellis extending above the pot and detachably attached thereto. The preferred attachment means having downwardly extending extensions on support posts of the trellis, and these extensions have a lip to engage ledges along the side of the pot and are reachable through apertures in the pot rim. This secures the trellis to the top and provides the necessary upper support for the branches and vines of growing plants to expose them to maximum sunlight and air. Unlike the present invention, the trellis framework would not provide the stability necessary to support a tabletop, as the framework does not teach or suggest any means to secure, or inhibit, a tabletop from sliding off if accidentally bumped or jostled.

U.S. Pat. No. 425,745 to Brown discloses a vase-shaped skeleton frame of wire consisting of vertical rods bent to give the shape of the trellis and formed at their lower ends into hooks, or clasps, that embrace the rim of the pot, combined with circular extendible hoops or wire rings, which may be enlarged or reduced in size to admit the lower end of the trellis to the circumference of the pot to which it is attached. Again, the wire frame of Brown would not be suitable for supporting a tabletop.

While the foregoing described prior art devices have advanced the art in a variety of ways, there nevertheless remains a need for an assembly which can be readily attached to a container, particularly a plant pot or the like, which easily coverts it into a table and vice versa, that is stable, economical to manufacture, simple to assemble, and permits an individual access to the interior cavity of the container therein without disassembling the stand.

### SUMMARY OF THE INVENTION

While the use of decorative tables and containers, and the like are known, prior to the instantly disclosed invention there was no adequate means in the art by which one could effectively or stability convert containers into a table and back into a container, as desired. To address this lack of prior art, disclosed is a table for use in combination with a container such as a flower pot or vase. The decorative table is formed from a frame that couples to the open end of the container wherein the container operates as a support base. A decorative item, such as a plant, is placed in therein and operates as a weighted base. A larger container with a heavier plant, and associated planting mix, provides a base that can support larger tables. A frame is secured to the container having a spaced upper end forming an upper support member. A planar tabletop is then secured to the upper support member providing a tabletop that can be used in a conventional manner.

Accordingly, it is the principle objective of this invention to provide a convenient, simple and safe means to convert a container into an aesthetically pleasing and functional table, while simultaneously providing easy access to the contents inside the container. Thus, the aforementioned problems of structural instability and inhibited access to the container contents are substantially reduced.

It is a further object of this invention to disclose an assembly where there is a substantially unobstructed view to the decorative items inside the container.

It is a further object of this invention to disclose an assembly, which can be used on commercially available, or supplied container.

Still another objection of this invention is to disclose an assembly that requires little use of tools, thereby requiring little skill by the user.

Another objective of the instant invention is to provide an assembly that is economical to manufacture in that it has few components.

Yet an additional objective of the instant invention is to provide an assembly that is easy to construct, and which, once assembled, is ease to disassemble. Other objectives and advantages of this invention will become apparent from the accompanying descriptions taken in conjunction with the accompanying drawings wherein are set forth, by way of illustration and example, certain embodiments of this invention. The drawings constitute a part of this specification and include exemplary embodiments of the present invention and illustrate various objects and features thereof. It will be readily appreciated by those skilled in the art that the use of multi-functional furniture for is highly effective in saving living space and useful in the design art.

### BRIEF DESCRIPTION OF THE FIGURES

FIG. 1 illustrates an upper perspective, exploded view of a first embodiment of the instant assembly;

FIG. 2 is an upper perspective, partially exploded view of the embodiment of FIG. 1, illustrating the attachment of the frame to the container;

FIG. 3 is the partially exploded view of FIG. 2 with the container shown in phantom;

FIG. 4 is a cross-sectional view of the instant assembly as seen along the longitudinal axis;

FIG. 5 is a top view of the instant assembly as seen with a glass tabletop;

FIG. 6 illustrates a second embodiment of the frame of the instant assembly with a urn-shaped container;

FIG. 7 illustrates the frame of FIG. 6 attached to an urn-shaped container;

FIG. 8 illustrates the frame of FIG. 7 housing a plant.

### DETAILED DESCRIPTION OF PREFERRED EMBODIMENTS

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to variously employ the present invention in virtually any appropriately detailed structure.

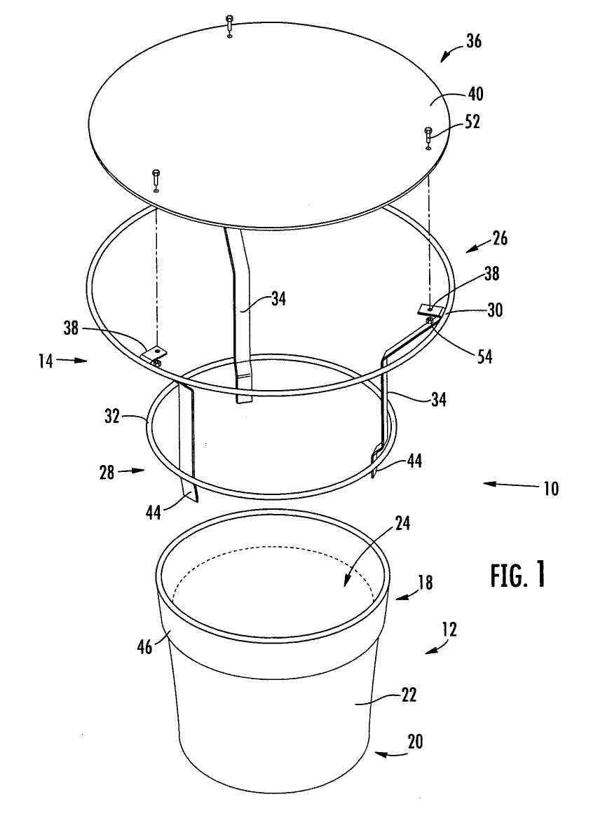

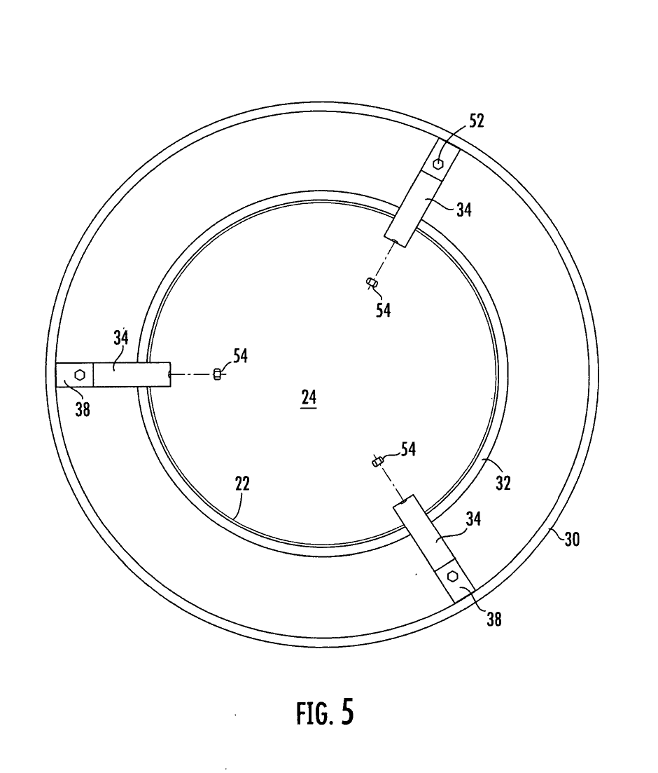

Referring now to FIGS. 1-8, wherein like elements are numbered consistently throughout, FIG. 1 shows an exploded view of one embodiment the instant multi-purpose decorative assembly, generally referenced as 10. By way of an overview, the assembly 10 comprises a container 12, a frame 14 and a table top 34.

The container 12 includes a first end 18, a second end 20, and at least one sidewall 22. The first end and second end 18, 20 of said container 12 are in spaced apart relation along a longitudinal axis thereof, thereby creating a cavity 24 constructed and arranged to receive said at least one decorative item 60, (e.g. plants, fish, colorful glass bulbs, sand, rocks, etc.) therein. For example, FIG. 8 illustrates the container 12 adapted to house a plant.

In addition, the first end 18 of the container 12 can include excess material, as commonly used in many plant containers as it reinforces the first end 18 of the container 12. The container 12 can be made from any material known in the art, e.g. plastic, wood, metal, ceramic, glass, terracotta, or combinations thereof.

While the shape of the container 12 is illustrated herein as cylindrical in FIGS, it is obvious that any shape can be used, (e.g. urn-shaped (FIGS. 7-8), spherical, cubic, etc). Moreover, the container 12 can be provided with interstices, relief patterns and the like made from the same or a different material than that of other parts of the container 12 for enhanced ornamentation.

As seen in FIGS. 1-8, the frame 14 includes an upper end 26 and a lower end 28 in spaced apart relation along the longitudinal axis thereof. At the upper end 26 of the frame 14 an upper support member is disposed illustrated herein as, albeit not limited to, a first annular ring 30. Similarly, a lower support member is disposed at said lower end 28 of the frame 14 illustrated herein as, albeit not limited to, a first annular ring 32. The upper and lower support members provide enhanced stability to the frame 14.

Although the first and second rings 30, 32, are depicted herein as a substantially circular shape, it would be obvious to the skilled artisan to modify the shape of either or both of the first or second rings 30, 32 as desired, (e.g. square, oval, triangular, etc). However, the second ring 32 should be shaped to correspond to the shape of the first end 18 of the container.

In addition, the frame 14 includes a plurality of support braces 34 attached to both said upper support and said lower support members by any means of attachment known in the art, such as, adhesives, welding, rivets, clamps, nut and bolt, screws, etc. The plurality of support braces 34 are illustrated herein as three substantially equidistant members joined along the circumference of the first and second rings 30, 32. It has been discovered that this particular configuration lends both adequate clearance for the user to access the interior 24 of the container 12, while providing structural integrity to the frame 14. However, it is contemplated that any number of support braces 34 may be used, depending on the material of the tabletop 36 and amount of clearance to the container's interior cavity 24.

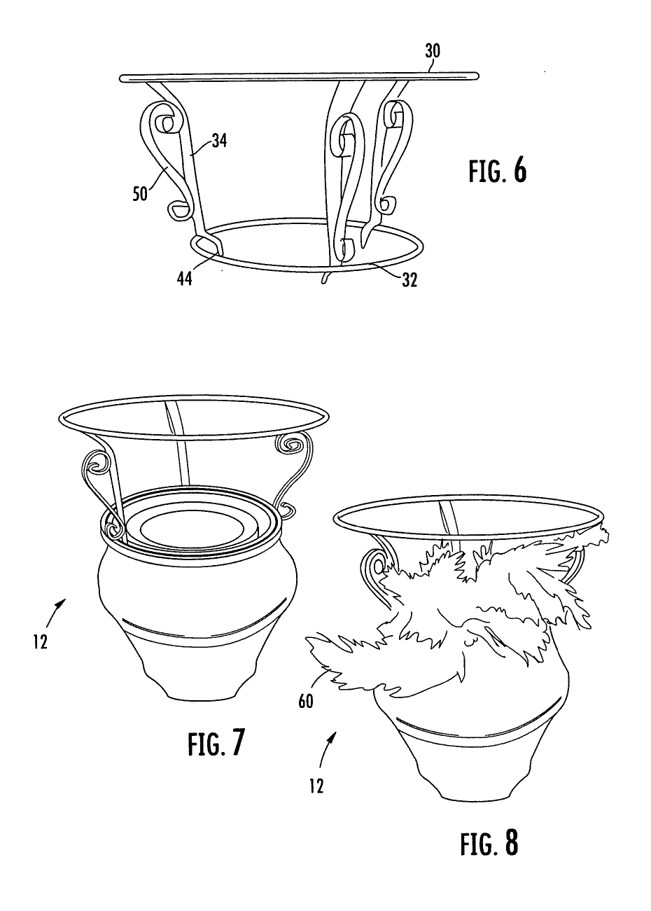

As shown in FIGS. 6-8, at least one of the plurality of support braces 34 can include buttresses 50 attached thereto by any means known in the art (e.g. welding, adhesives, etc) These buttresses 50 act as both a decorative and stabilizing element.

The ratio of the diameter of first ring 30 to second ring 32 can be from about 2:1 to about 1:1, wherein 1.5:1 is preferred. The spaced-apart distance between the first and second ring 30, 32, as measured along the longitudinal axis thereof, can be anywhere between about 12 inches to 24 inches, as desired, with 13.5 particularly preferred. Although not illustrated herein, it is contemplated that only a single or plurality of support members may be used. Employing a plurality of support members act to both ameliorate the structural integrity of the frame 14 and provide a trellis for a climbing plants.

In addition, the upper end 26 of the frame 14 includes a plurality of inwardly (i.e. laterally) projecting tabletop supporting means 38. The plurality of projecting tabletop supporting means 38 can be of any size or shape and can be either integrally formed with a support brace 34 as illustrated in FIGS. 1-3, 5; otherwise, the support brace 34 can be attached at any point along the upper support member, i.e. first annular ring 30.

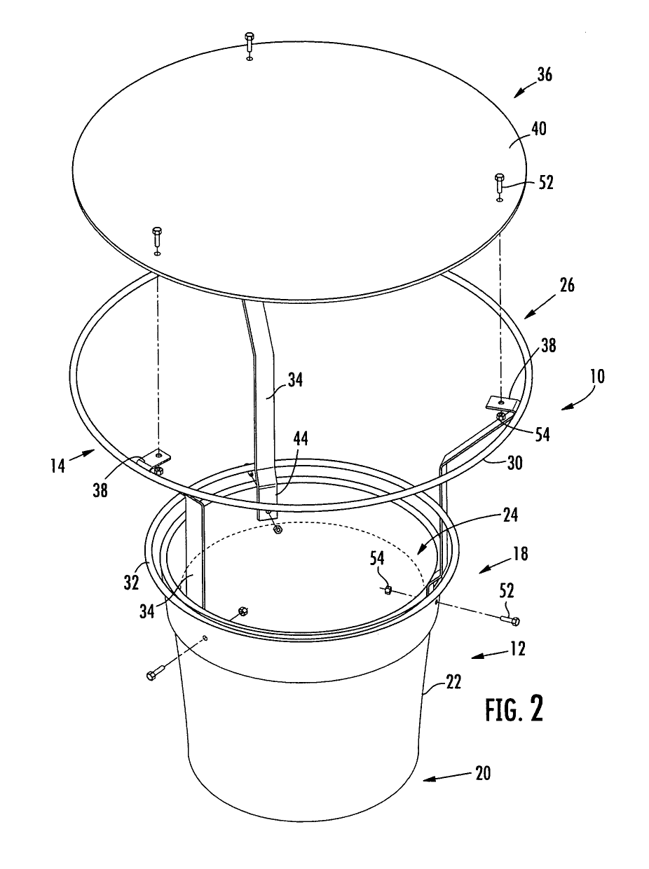

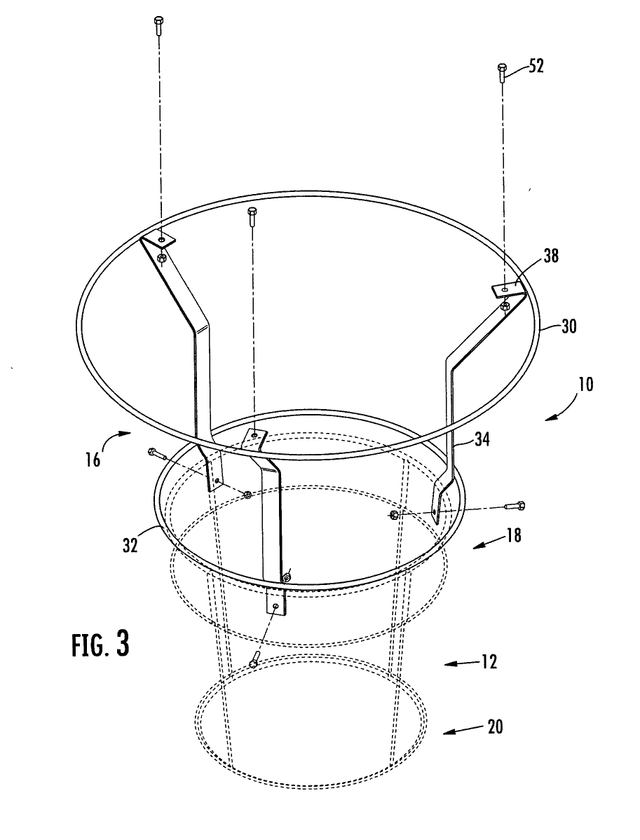

The lower end 28 of the frame support includes at least one downwardly (i.e. longitudinally) disposed extension means 44. The extension means 44 can be either integrally formed with a corresponding support brace 34 as illustrated in FIGS. 1-3; otherwise, the support brace 34 can be integrally formed at any point along the lower support member, i.e. second annular ring 32. As illustrated in FIGS. 2-3, these extension means 44 can include apertures for receiving a removable attachment means shown here as, albeit not limited to, a bolt 52 and nut 54. However, other means of removable attachment could be used, such as pin and coddle, screw, clamp and the like.

Although not is illustrated herein, it is contemplated that an additional extension means could be disposed substantially parallel to the extension means 44 such that they simultaneously clasp the inner and outer surface of the sidewall 22 at the first end 18 of the container, thereby forming a stable attachment to the container 12. Furthermore, both of these extension means 44 can include apertures for receiving any removable attachment means known to those of skill in the art.

All of the aforementioned components of the frame 14 can be composed of any rigid or semi-rigid material desired, for instance, metal, wood, plastic, ceramic, and the like.

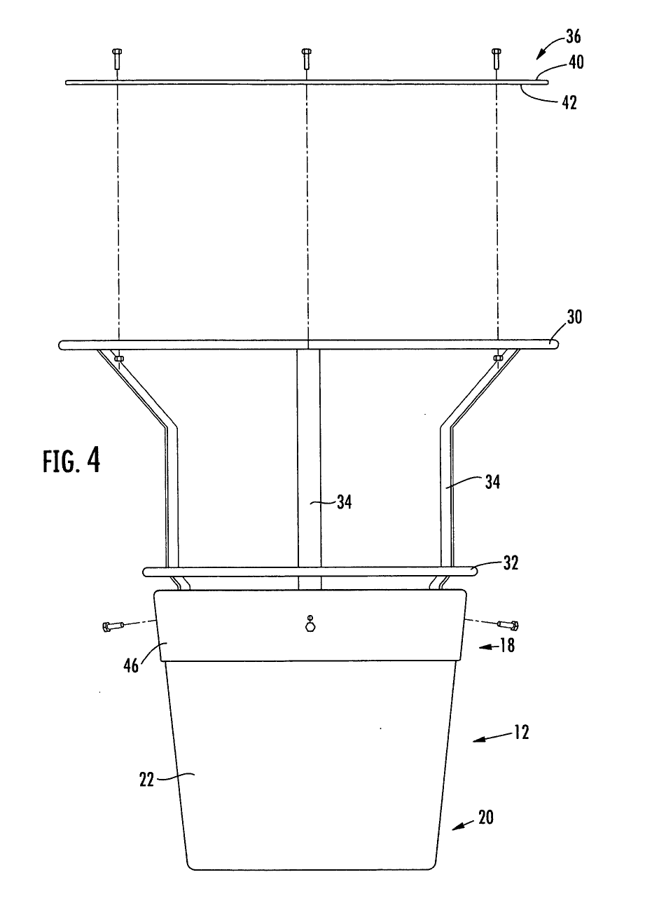

The planar tabletop 36 has an upper surface 40 and a lower surface 42 (FIG. 4), wherein said planar tabletop 36 is constructed and arranged for removable attachment thereto. Otherwise, the tabletop 36 can be pressed against the substantially laterally formed tabletop support means 38 by clips, clamps, and the like.

In one preferred embodiment illustrated in the FIGS. 1-4, albeit not limited to, the planar tabletop 36 can include a plurality of apertures formed therethrough, wherein the location of apertures correspond to the location of the plurality of support braces 34, each of which having apertures therein, such that a bolt 52 and nut 54 configuration can be inserted substantially parallel to the longitudinal axis from either the upper or lower surface 40, 42 of the table top 36.

In a preferred embodiment, the tabletop 36 is constructed and arranged such that its outer perimeter is less than the inner diameter of the first annular ring 30, so that the bottom surface 42 of the table rests against the table top support means 38, whereby most of the thickness of the tabletop 36 is surrounded by the annular ring 30 to prevent the table top from sliding off the support means 38.

The tabletop 36 can be composed of any rigid or semi-rigid material desired, for instance, metal, wood, plastic, ceramic, or the like. In a preferred embodiment, the tabletop 36 is comprises a clear, semi-opaque, or opaque glass or combinations thereof. Moreover, the upper surface 40 and lower surface 42 can be smooth, rough, provided with interstices, relief patterns and the like for enhanced ornamentation.

In all of the above mentioned embodiments, the user can readily convert the container 12, which may be empty or housing a decorate item therein, into a stable, multi-purpose table, as shown in FIGS. 7, 8. Upon assembly, the user simply attaches and secures the extension means 44 to the first end 18 of the container 12 by any means of attachment known in the art. Next, the tabletop 36 is placed upon and secured to the tabletop support means 38. The assembly procedure is simply reversed to convert the table back to the container 12.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The various apparatus, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A decorative table frame for use in combination with a container to produce a decorative table, said container defined as a first end, a second open end, and a continuous sidewall therebetween, said first end and said second end of said container are in spaced apart relation along a longitudinal axis thereof, thereby defining a cavity adapted to receive at least one decorative item therein, said decorative table frame comprising;
a lower end including a lower support member securable to said container and a spaced apart upper end, said upper end including an upper support member, said upper support member further includes a first annular ring capable of holding a planar tabletop thereon, wherein the outer perimeter of said first annular ring is less than the outer perimeter of said tabletop to prevent said tabletop from sliding off said upper support member;
wherein said container operates as a decorative base for a table upon securement of said frame to said container thereby providing support for said tabletop.

2. The frame according to claim 1 wherein said frame includes a plurality of support braces attached to both said upper support and said lower support members and disposed substantially parallel to the longitudinal axis.

3. The frame according to claim 2 wherein support braces include inwardly projecting table top supporting means.

4. The frame according to claim 1 wherein said planar tabletop has an upper surface and a lower surface, wherein said planar table top is adapted for removable attachment to said frame.

5. The frame as set forth in claim 1, wherein said lower support member includes at least one integrally formed longitudinally projecting extension, wherein said first end of said container and said at least one extension are removably attached to secure said frame to said container.

6. (canceled)

7. (canceled)

8. The frame as set forth in claim 2, wherein said lower support member further comprises a second annular ring for enhanced stability of the lower end of said frame.

9. The frame as set forth in claim 8, wherein the diameter of said first annular ring is at least greater than said second annular ring.

10. (canceled)

11. The frame as set forth in claim 1, wherein said frame is constructed from a substantially rigid material selected from the group consisting of plastic, metal, ceramic, wood and combinations thereof.

12. A multi-purpose decorative assembly convertible between a table to a container for displaying at least one decorative item therein, said assembly comprising in combination:
said container including a first end, a second end, and at least one sidewall, said first end and said second end of said container are in spaced apart relation along a longitudinal axis thereof, thereby defining a cavity adapted to receive said at least one decorative item therein;
a frame with an upper end and a lower end in spaced apart relation along the longitudinal axis thereof, said frame includes an upper support member including a first annular ring disposed at said upper end and a lower support member including a second annular ring disposed at said lower end of said frame, and a plurality of support braces attached to both said upper support and said lower support members and disposed substantially parallel to the longitudinal axis, said frame constructed and arranged to support a planar tabletop while providing removable attachment to said first end of said container, wherein the outer perimeter of said first annular ring is less than the outer perimeter of said tabletop to prevent said tabletop from sliding off said upper support member; and
said planar tabletop has an upper surface and lower surface, wherein said planar table top is adapted for removable attachment to said upper support means;
wherein said container is converted from a container for housing at least one decorative item therein into a stable, multi-purpose table upon attachment of said frame to said container and said table top, wherein said at least one decorative item is positioned and readily accessible within an interior space defined by said cavity and said lower surface of said table top.

13. The assembly as set forth in claim 12, wherein said lower support member includes at least one integrally formed longitudinally projecting extension, wherein said first end of said container and said at least one extension are removably attached to secure said frame to said container.

14. (canceled)

15. (canceled)

16. (canceled)

17. The assembly as set forth in claim 12, wherein the diameter of said first annular ring is at least greater than said second annular ring.

18. (canceled)

19. The assembly as set forth in claim 12, wherein said frame is constructed from a substantially rigid material selected from the group consisting of plastic, metal, ceramic, wood and combinations thereof.

20. A frame for use in combination with a container to create a decorative table, said container defined as having a first end, a second open end, and a continuous sidewall therebetween, said first end and said second end of said container are in spaced apart relation along a longitudinal axis thereof, thereby defining a cavity adapted to receive at least one decorative item therein, said frame comprising;
an upper end and a lower end in spaced apart relation along the longitudinal axis thereof, said frame includes a first annular ring disposed at said upper end and a second annular ring disposed at said lower end of said frame, and a plurality of support braces attached to both said first annular ring and said second annular ring and disposed substantially parallel to the longitudinal axis, wherein said perimeter of said first annular ring is at least greater than said second annular ring;
wherein said container operates as a decorative base for a table upon securement of said frame to said container thereby providing support for a tabletop.

21. The frame according to claim 20 wherein said support braces include inwardly projecting table top supporting means.

22. The frame according to claim 20 wherein said planar tabletop has an upper surface and a lower surface, wherein said planar table top is adapted for removable attachment to said frame.

23. The frame as set forth in claim 20, wherein said second annular ring includes at least one integrally formed longitudinally projecting extension, wherein said first end of said container and said at least one extension are removably attached to secure said frame to said container.

24. The frame as set forth in claim 20, wherein the an outer perimeter of said planar tabletop is less than the outer perimeter of said first annular ring, thereby precluding said tabletop from sliding off said frame.

25. The frame as set forth in claim 20, wherein said frame is constructed from a substantially rigid material selected from the group consisting of plastic, metal, ceramic, wood and combinations thereof.

26. A multi-purpose decorative assembly convertible between a table to a container for displaying at least one decorative item therein, said assembly comprising in combination:
said container including a first end, a second end, and at least one sidewall, said first end and said second end of said container are in spaced apart relation along a longitudinal axis thereof, thereby defining a cavity adapted to receive said at least one decorative item therein;
a frame means having an upper end and a lower end in spaced apart relation along the longitudinal axis thereof, said frame includes a first annular ring disposed at said upper end and a second annular ring disposed at said lower end of said frame, and a plurality of support braces attached to both said first annular ring and said second annular ring and disposed substantially parallel to said longitudinal axis, wherein said perimeter of said first annular ring is at least greater than said second annular ring; and
a planar tabletop has an upper surface and lower surface, wherein said planar table top is adapted for removable attachment to said upper end;
wherein said container is converted from a container for housing at least one decorative item therein into a stable, multi-purpose table upon attachment of said frame to said container and said table top, wherein said at least one decorative item is positioned and readily accessible within an interior space defined by said cavity and said lower surface of said table top.

27. The assembly as set forth in claim 26, wherein said lower end of said frame includes at least one integrally formed longitudinally projecting extension, wherein said first end of said container and said at least one extension are removably attached to secure said frame to said container.

28. The assembly as set forth in claim 26, wherein the an outer perimeter of said planar tabletop is less than the outer perimeter of said first annular ring, thereby precluding said tabletop from sliding off said frame.

29. The assembly as set forth in claim 26, wherein said frame is constructed from a substantially rigid material selected from the group consisting of plastic, metal, ceramic, wood and combinations thereof.
